(19) United States
(12) Patent Application Publication
(10) Pub. No.: US 2008/0075816 A1
(43) Pub. Date: Mar. 27, 2008

(54) Dairy-based product and method and process for producing same

(76) Inventors: Mark W. Jensen, Papillion, NE (US); Jess Sweley, Omaha, NE (US); Jennifer Fichter Smith, Seattle, WA (US); Rudolph Carlson, Eau Claire, WI (US); Gabrielle Egli, Omaha, NE (US); Carl Jalowitz, Menomonic, WI (US); Scott Jobman, Omaha, NE (US); Roger Anderson, Prairie Farm, WI (US)

Correspondence Address: SUITER SWANTZ PC LLO, 14301 FNB PARKWAY, SUITE 220, OMAHA, NE, 68154, US

(21) Appl. No.: 11/903,344

(22) Filed: Sep. 21, 2007

Related U.S. Application Data
(60) Provisional application No. 60/846,425, filed on Sep. 21, 2006.

(51) Int. Cl. A23C 9/00; A23C 3/02; A23C 9/152; A23C 9/154; A23C 7/00

(52) U.S. Cl. 426/250; 426/329; 426/334; 426/474; 426/564; 426/572; 99/453

(57) ABSTRACT

A dairy-based product comprises an aerated, non-cultured dairy-based component, and a stabilizer for stabilizing at least one air cell within the aerated, non-cultured dairy-based component.

### CROSS-REFERENCE TO RELATED APPLICATIONS

The present application claims the benefit under 35 U.S.C. § 119(e) of U.S. Provisional Application Ser. No. 60/846,425, filed Sep. 21, 2006. Said U.S. Provisional Application Ser. No. 60/846,425 is herein incorporated by reference in its entirety.

### TECHNICAL FIELD

The disclosure generally relates to the field of dairy-based products, and more particularly to an aerated, non-cultured dairy-based product, such as mousse.

### BACKGROUND

As society progresses, the frequency of sit down meals has decreased, and the utilization of portable, ready-to-eat snack food products has increased. Consumers may desire snack foods that are organoleptically pleasing. Consumers may also desire nutritious snack foods. Additionally, consumers may desire snack foods that have long shelf-lives.

### SUMMARY

The disclosure is directed to a dairy-based product and to a method and system for producing a dairy-based product.

The dairy-based product comprises an aerated, non-cultured dairy-based component, and a stabilizer for stabilizing at least one air cell within the aerated, non-cultured dairy-based component.

The system for producing a dairy-based product comprises a first mixer for mixing components to form a first mix, a second mixer for mixing the first mix and ingredients to form a final mix, a pasteurizer for pasteurizing the final mix to form a pasteurized composition, an aerator for aerating the final mix in the pasteurizer, and a filler for inserting the pasteurized composition into a package.

The method for producing a dairy-based product comprises mixing components to form a first mix, mixing the first mix and ingredients to form a final mix, pasteurizing the final mix to form a pasteurized composition, aerating the final mix during pasteurizing, and inserting the pasteurized composition into a package.

It is to be understood that both the foregoing general description and the following detailed description are exemplary and explanatory only. The accompanying drawings, which are incorporated in and constitute a part of the specification, illustrate examples and together with the general description, serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is an isometric view illustrating a dairy-based product;

FIG. 2 is a side cross-sectional view of the dairy-based product as illustrated in FIG. 1;

FIG. 3 is an isometric view illustrating a layered dairy-based product;

FIG. 4 is a side cross-sectional view of the layered dairy-based product as illustrated in FIG. 3;

FIG. 5 is an isometric view of the layered dairy-based product as illustrated in FIG. 3;

FIG. 6 is a flow diagram illustrating a method for producing a dairy-based product;

FIG. 7 is a flow diagram illustrating a process for producing a dairy-based product; and

FIG. 8 is a block diagram illustrating a system for producing a dairy-based product.

### DESCRIPTION

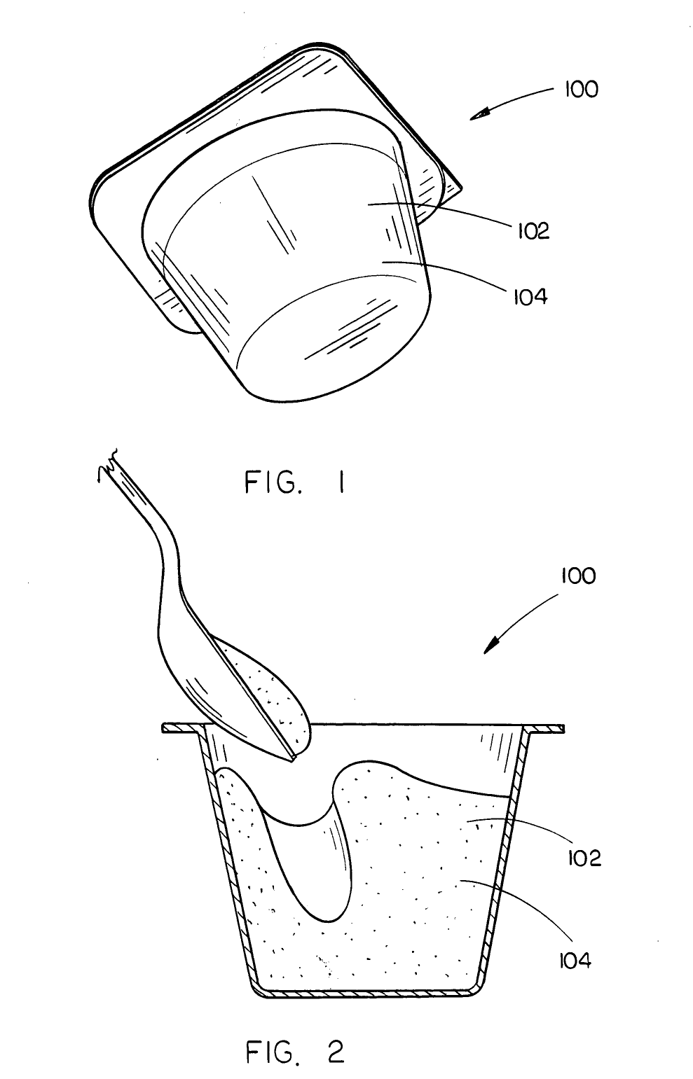

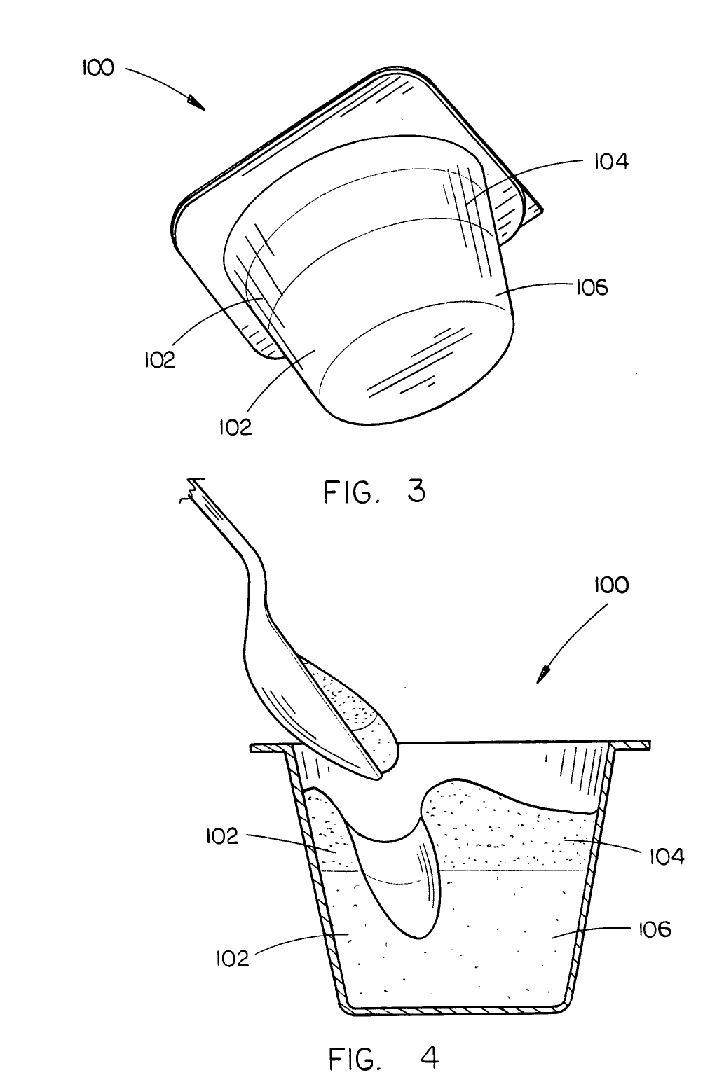

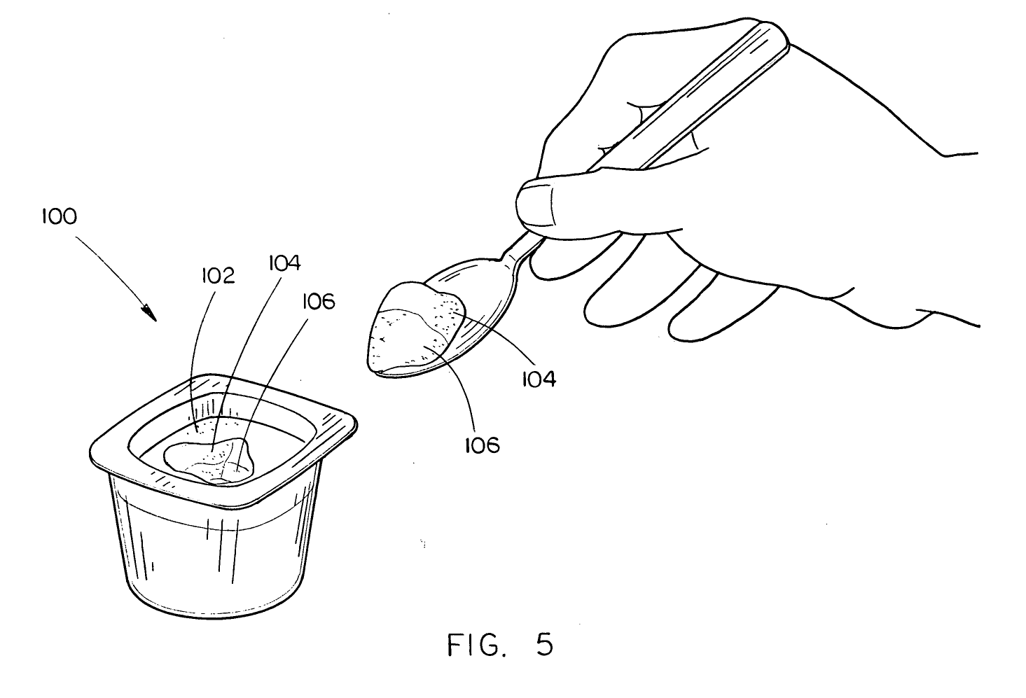

Referring generally to FIGS. 1 through 5, an isometric view of a dairy-based product 100 is shown. The dairy-based product 100 comprises a non-cultured dairy-based component 102. As used herein “non-cultured” refers to a food product that has not been fermented or cultured. A non-cultured dairy-based product has proteins that have undergone less degradation than the proteins in a cultured dairy-based product. The proteins of the non-cultured dairy-based product have higher functionality and are more organolepticaltly (e.g., taste and texture) pleasing than the proteins in a cultured dairy product because the proteins are not as degraded. As used herein “dairy-based” refers to a food product that contains at least 5% dried milk, at least 33% liquid milk, or a combination of dried milk and liquid milk comparable to the at least 5% dried milk and/or the at least 33% liquid milk.

The dairy-based product 100 may comprise multiple non-cultured dairy-based components 102. The dairy-based product 100 comprises at least one of the non-cultured dairy-based component 102 that is aerated, such as an aerated/whipped pudding or a mousse. As used herein “aerated” refers to injecting a gas, such as air, nitrogen, or any other suitable gas for aerating and/or whipping a food product, into a food product and substantially retaining the gas within the food product in a generally dispersed manner for the shelf-life of the food product.

The non-cultured dairy-based component 102 may be a milk based component. The non-cultured dairy-based component 102 may include other ingredients, such as oil, salt, water, cocoa, sugar, starch, colorings, sodium stearoyl lactylate, and/or flavorings. This list is not restrictive. It is contemplated that other ingredients may be utilized in the non-cultured dairy-based component without departing from the scope and intent of the disclosure. The flavorings may include vanilla, butterscotch, caramel, strawberry, mocha, coffee, chocolate, and/or mochaccino. This list is not restrictive. It is appreciated that other flavorings may be utilized without departing from the scope and intent of the disclosure.

An aerated, non-cultured dairy-based component 104 comprises a stabilizer. A non-aerated, non-cultured dairy-based component 106 may or may not contain a stabilizer. The stabilizer may stabilize at least one air cell within the aerated, non-cultured dairy-based component 104. The stabilizer may comprise a gum and a gelatin. The gum may be a xanthan gum, a carrageenan gum, a guar gum, a locust bean gum, and/or a karaya based gum. The gum is utilized to provide viscosity, suspension, and emulsion stability. The gum may be any gum or combination of gums 1) capable of withstanding high thermal processing and remaining stable at refrigeration temperatures, 2) compatible with gelatin and sodium stearoyl lactylate, 3) capable of withstanding process shearing pumps and scrape surface heat exchanger (SSHE), and 4) capable of suspending and stabilizing dispersed gasses in aqueous systems. The gum may be a xanthan gum. The xanthan gum may have several beneficial qualities, such as high viscosity at tow concentrations, excellent temperature stability during processing, compatibility with other ingredients, good freeze/thaw stability, good shear stability, and tolerance of a wide range of pH conditions. The aerated, non-cultured dairy-based component 104 may comprise about 0.01% to about 0.30% by weight of gum. The gelatin may be any suitable gelatin for a dairy-based product. The aerated, non-cultured dairy-based component 104 may comprise about 0.10% to about 1% by weight of gelatin.

A first non-cultured dairy-based component 102 may be layered on top of a second non-cultured dairy-based component 102 for distinct organoteptic profiles. It is contemplated that as many layers of a non-cultured dairy-based component 102 as desired may be utilized in the dairy-based product 100 to produce distinct organoleptic profiles. It is understood that the layers comprise at least one aerated, non-cultured dairy-based component 104. The dairy-based product 100 may also comprise a non-aerated dairy-based component 106, such as a pudding or a tapioca layer.

The aerated, non-cultured dairy-based component 104 may have different levels of aeration. Aeration may be measured as overrun. Overrun may determine the percentage of gas incorporated into a product. To measure overrun a container with a standardize volume may be utilized. Overrun may be calculated as shown below:

$$Percent Overrun = \frac{\begin{matrix}( Weight of non \text{-} aerated product in a \\ standardized volume container - \\ Weight of an aerated product in the same \\ standardized volume container )\end{matrix}}{\begin{matrix}Weight of the aerated product in the same \\ standardized volume container\end{matrix}} \times 100$$

When the overrun is calculated, the container may be filled so the product is level with the top of the container and both the aerated and non-aerated product may be filled at an approximate fill temperature within about 5° F. of each other.

The dairy-based product 100 may have an overrun of about 15% to about 50%. The overrun percentage may be changed as desired. In order to implement the higher overrun percentages, the amount of fat and/or gum may be increased in the product. The dairy-based product 100 may have an overrun of about 20% to about 35%. The dairy-based product 100 may have an overrun of about 25%. These overrun calculations may be conducted after filling the package. A dairy-based product with an aerated, non-cultured dairy-based component 104 may lose up to about 10% of the gas incorporated into the dairy-based product during the filling of the package.

Typically, the non-aerated, non-cultured dairy-based component 106 may have a density of about 1.0 g/mL to about 1.2 g/mL in a package and/or container with a volume of 43.60 mL. The aerated, non-cultured dairy-based component 104 may have a density of about 0.75 g/mL to about 0.90 g/mL in a package and/or container with a volume of 43.60 mL. This list is not restrictive. It is understood that other densities may be utilized without departing from the scope and intent of the disclosure.

The dairy-based product may have a generally neutral pH. Further, the dairy-based product may be refrigerated for an extended storage. The dairy-based product does not require freezing and/or storage in a pressurized container in order to maintain an extended shelf life and/or aeration. The dairy-based product may have a shelf life of 24 months or less. The dairy-based product may have a shelf life of 12 months or less. The dairy-based product may have a shelf life of 6 months or less. The dairy-based product may have a shelf life of 2 months or less.

Consumers may desire different levels of fat depending upon their different nutritional preferences and needs. The dairy-based product 100 may contain different levels of fat. The dairy-based product 100 may contain about 2% to about 50% fat. The dairy-based product 100 may comprise about 2% to about 6.5% fat. To achieve lower levels of fat, an increase in the amount of gelatin and/or an increase in the amount of gums and/or combination of different gums, such as xanthan gum, locust bean gum, carrageenan gum, and/or guar gum, may be utilized. This list is not restrictive. It is appreciated that other suitable gums may be utilized without departing from the scope and intent of the disclosure.

The dairy-based product 100 may comprise numerous flavors and colors. The dairy-based product 100 may be colored or flavored to accommodate holidays, such as pumpkin flavored, egg-nog flavored, or patriotic coloring. Additionally, the dairy-based product 100 may comprise additional food particulates for desired organoleptic effects, such as nuts, chocolate chips, wafers, granola, fruit, candy and/or any other desired particulate suitable for dairy-based products. The food particulates may be contained in the dairy-based product 100 or contained within a separate packet.

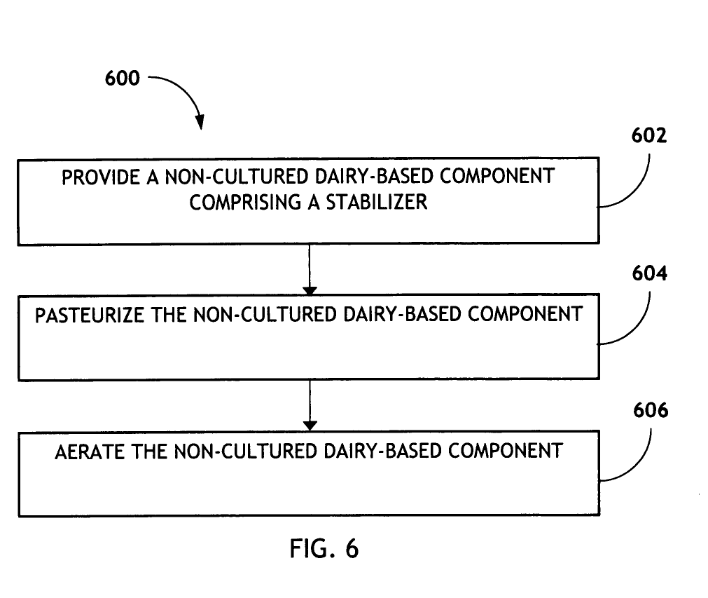

Referring to FIG. 6 a flow diagram of a method for producing a dairy-based product 600 is shown. Method 600 provides a non-cultured dairy-based component comprising a stabilizer, 602. Method 600 pasteurizes the non-cultured dairy-based component, 604. Method 600 aerates the non-cultured dairy-based component, 606. The pasteurized and aerated non-cultured dairy-based component forms a dairy-based product.

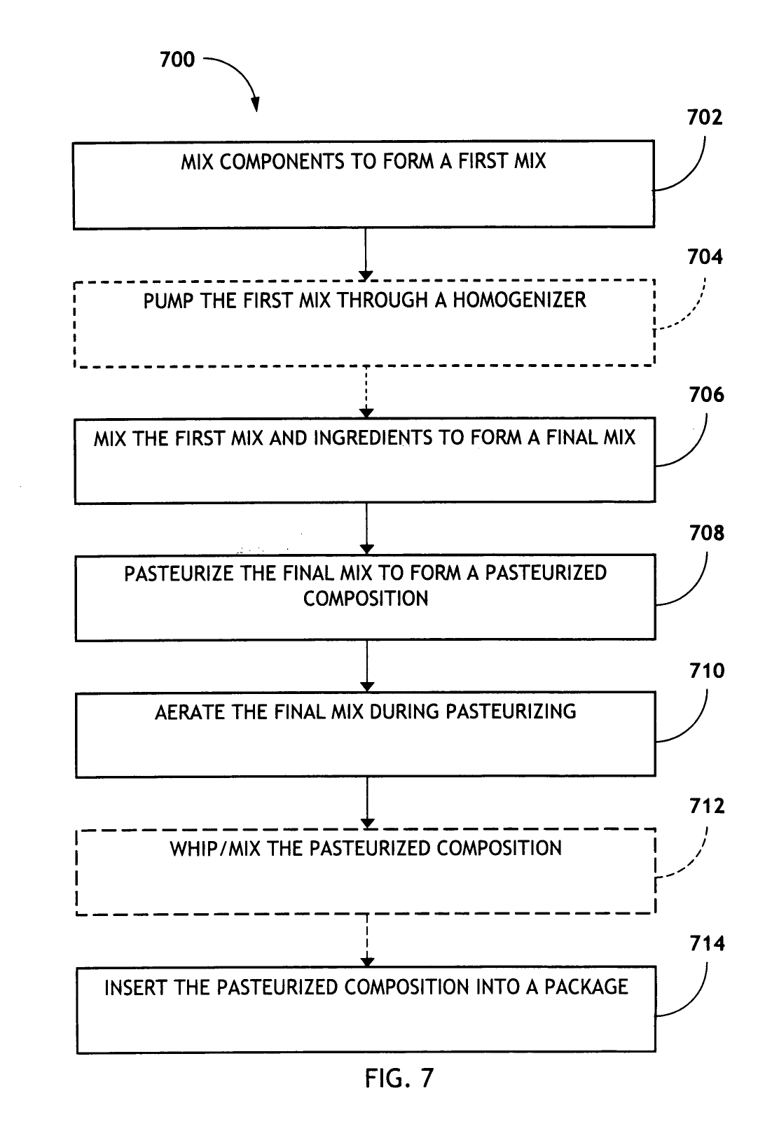

Referring to FIG. 7 a flow diagram of a method for producing a dairy-based product 700 is shown. Method 700 mixes components to form a first mix, 702. Method 700 may pump the first mix through a homogenizer, 704. Method 700 mixes the first mix and ingredients to form a final mix, 706. Method 700 pasteurizes the final mix to form a pasteurized composition, 708. Method 700 aerates the final mix during pasteurizing, 710. Method 700 may whip or mix the pasteurized composition, 712. Method 700 inserts the pasteurized composition into a package, 714.

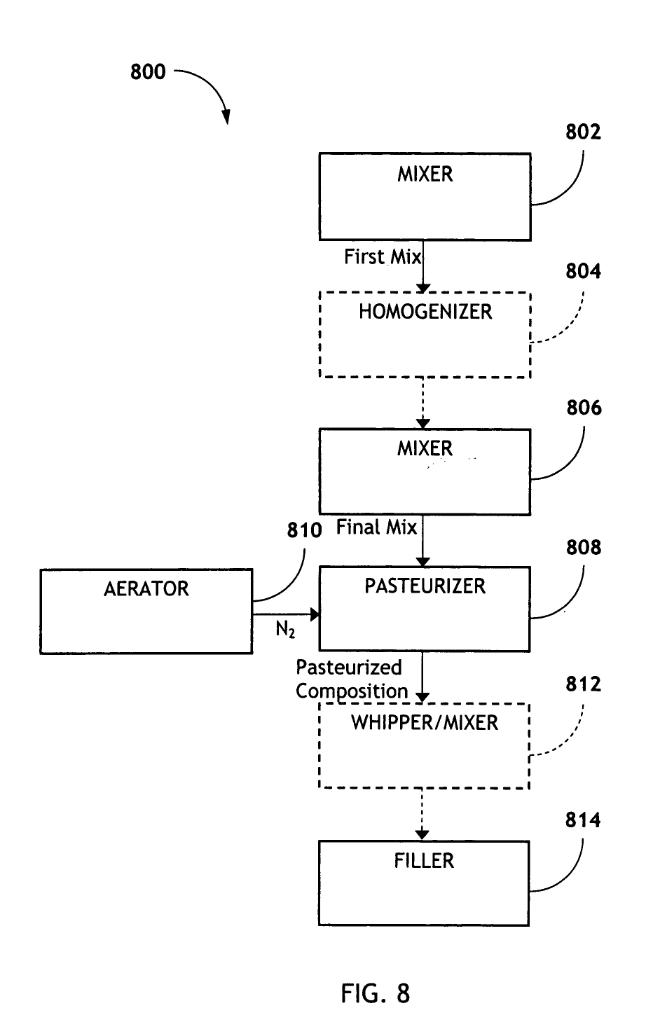

Referring to FIG. 8 a block diagram of a system for forming a dairy-based product 800 is shown. The system for forming a dairy-based product 800 may comprise a mixer 802, a mixer 806, a pasteurizer 808, an aerator 810, and a filler 814. The system 800 may also comprise a homogenizer 804 and/or a whipper/mixer 812. Method 600 and process 700 may be executed by the system 800 of FIG. 8.

The mixer 802 mixes components such as, oil, sodium stearoyl lactylate, and water, to form a first mix. This list is not restrictive. It is appreciated that other components may be added to the first mix without departing from the scope and intent of the disclosure. The first mix may be pumped through a homogenizer 804. The first mix may be more than 10% by weight of the dairy-based component. Ingredients, such as milk, sugar, water, starch, stabilizer and flavorings, and the first mix may be mixed in the mixer 806 to form a final mix. The final mix may be pasteurized in a pasteurizer 808 to form a pasteurized composition.

The pasteurizer 808 may be a scrape surface heat exchanger (SSHE). The SSHE may have a heat section, a tower water section, and an ammonia section. The heat section utilizes steam as a heating medium to heat the final mix. The tower water section utilizes cold water as a cooling medium to cool the heated final mix. The ammonia section utilizes ammonia as a cooling medium to further cool the final mix. The SSHE may be a closed system. The SSHE may utilize high heat for about 280 minutes. The SSHE may reduce the amount of vegetative microorganism and reduce the amount of spores in the final mix. The SSHE may be a Contherm™ produced by Alfa Laval in 4405 Cox Road, Suite 130, Glen Allen, Va. 23060. The aerator 810 injects gas into the final mix while the final mix is in the pasteurizer 808. The aerator 810 may inject gas into the final mix in the SSHE before the final mix enters the ammonia section. The aerator 810 may inject gas into the final mix in the SSHE before the final mix enters the tower water section. The gas may be injected in the pasteurizer to allow the gas to disperse throughout the final mix.

The pasteurized composition may be mixed and/or whipped in a whipper/mixer 812. The whipper/mixer 812 breaks up the gas into smaller bubbles in the pasteurized composition. The whipper/mixer 812 may provide a texture that is uniform and organoleptically pleasing to a consumer. The whipper/mixer 812 may be a CR Mixer™ produced by Waukesha Cherry-Burrell in 611 Sugar Creek Road, Delavan, Wis. 53115 or an Oakes Mixer™ produced by Machinery and Equipment Company, Inc. in 3401 Bayside Boulevard, Brisbane, Calif. 94005. The pasteurized composition may be run through a filler 814. The filler 814 may have numerous fill spouts and contain numerous non-cultured dairy-based components. The filler 814 may put the non-cultured dairy-based component into a package or container. The package/container may comprise any suitable material for storing the dairy-based product and may be in any suitable size or shape for storing the dairy-based product. The filler may put a first non-cultured dairy-based component into a portion of a package and put a second non-cultured dairy-based component into a portion of the package to form a layered dairy-based product. The filler may put a third non-cultured dairy-based component into a portion of the package to form a layered dairy-based product. At least one of the non-cultured dairy-based components in the layered dairy-based product is an aerated, non-cultured dairy-based component.

### EXAMPLE 1

A non-cultured dairy-based product was produced. The non-cultured dairy-based product was a French chocolate mousse. Oil, sodium stearoyl lactylate, hot water (at a temperature of about 150° F. to about 180° F.), and cocoa are mixed together in a mixer to form a first mix. The oil may be a coconut oil. The first mix was pumped through a homogenizer and into another mixer. The first mix was mixed with liquid milk, sugar, dried milk, 96% T.S., starch, gum, gelatin, and flavorings to form a final mix. The final mix was pasteurized with a scrape surface heat exchanger and aerated with nitrogen in the scrape surface heat exchanger before cooling to produce the aerated, non-cultured dairy-based product or French chocolate mousse. The dairy-based product had a pH of about 6.4 to about 7.0 and an overrun of about 20% to about 30%.

### EXAMPLE 2

A non-cultured dairy-based product was produced. The non-cultured dairy-based product was layered with two different aerated, non-cultured dairy-based components. The first aerated, non-cultured dairy-based component was a French chocolate mousse and the second aerated, non-cultured dairy-based component was a mocha mousse layer. The first aerated, non-cultured dairy-based component was produced by: 1) forming a first mix of oil, sodium stearoyl lactylate, hot water at a temperature of about 150° F. to about 180° F., and cocoa; 2) mixing the first mix with skim milk, sugar, 96% T.S., starch, gum, gelatin and vanilla flavoring to form a final mixture; 3) pasteurizing the final mixture with a scrape surface heat exchanger and aerating with nitrogen in the scrape surface heat exchanger before cooling. The first non-cultured aerated dairy-based component was utilized to fill 45% by volume of a package or container. The second aerated, non-cultured dairy-based component (the mocha mousse layer) was produced by: 1) forming a first mix of oil, sodium stearoyl lactylate, hot water at a temperature of about 150° F. to about 180° F., and cocoa; 2) mixing the first mix with cold water at a temperature of about 40° F. to about 55° F., milk, sugar, 96% T.S., starch, gum, gelatin, coffee, mochaccino flavoring, and vanilla flavoring to form a mixture; 3) pasteurizing the mixture with a scrape surface heat exchanger and aerating with nitrogen in the scrape surface heat exchanger. The second non-cultured aerated dairy-based component was utilized to fill the remaining 55% by volume of the package or container holding the first non-cultured aerated dairy-based component to form the layered, non-cultured dairy-based product. The layered dairy-based product had a pH of about 6.4 to about 7.0 and an overrun of about 20% to about 30%.

### EXAMPLE 3

A non-cultured dairy-based product may be produced. The non-cultured dairy-based product may be a vanilla whipped pudding. Oil, sodium stearoyl lactylate, and hot water may be mixed together in a mixer to form a first mix. The first mix may be pumped through a homogenizer and into another mixer. The first mix may be mixed with sugar, dried milk, starch, cold water, gum, gelatin, coloring, and flavoring, such as vanilla to form a final mix. The final mix may be pasteurized with a scrape surface heat exchanger and aerated with nitrogen and/or air in the scrape surface heat exchanger before cooling to produce an aerated dairy-based product.

### EXAMPLE 4

The amount of air retained in the aerated, non-cultured dairy-based component varies depending upon the fat level of the dairy-based component. Fourteen runs of a dairy-based component were made utilizing different variables to measure the variables effects on the percentage of gas incorporated into the aerated, non-cultured dairy-based component (or on overrun). The fat level of the aerated, non-cultured dairy-based component was varied from containing 3.5% oil to 6% oil. The injection site of the gas was varied from Site 1 (before the water tower section of the SSHE) to Site 2 (before the ammonia section of the SSHE). Lastly, the utilization of a whipper was varied from utilizing a whipper, to not utilizing a whipper, to varying the whip speed (1200 rpm or 600 rpm). The table below lists all of the different runs, the runs' variables, and the runs' resulting overrun. The 14 runs are listed from the highest overrun percentage to the lowest.

| | | Air | Injection | Whip Speed | Drain | Min. | Max. | Average |
|---|---|---|---|---|---|---|---|---|
| Run | Oil % | Level % | Site | Rpm | Air % | Air % | Air % | Air % |
| 14 | 6 | 30 | Site 2 | 1200 | 29.5 | 26.57 | 28.15 | 27.57 |
| 13 | 6 | 20 | Site 2 | 1200 | 20 | 23.42 | 26.22 | 24.64 |
| 12 | 6 | 30 | Site 1 | None | 30+ | 22.53 | 25.17 | 24.01 |
| 8 | 6 | 30 | Site 2 | 600 | 28 | 23.07 | 24.12 | 23.60 |
| 10 | 6 | 20 | Site 1 | None | 20 | 21.29 | 23.14 | 21.93 |
| 7 | 6 | 20 | Site 2 | 600 | 20 | 20.88 | 23.05 | 21.66 |
| 15 | 3.5 | 30 | Site 2 | 1200 | 27.5 | 20.62 | 22.39 | 21.28 |
| 11 | 6 | 30 | Site 2 | None | 24.5 | 20.09 | 21.06 | 20.36 |
| 2 | 3.5 | 20 | Site 1 | None | 20.5 | 17.64 | 20.81 | 19.51 |
| 9 | 6 | 20 | Site 2 | None | 20 | 17.53 | 20.00 | 19.11 |
| 16 | 3.5 | 20 | Site 2 | 1200 | 20 | 18.49 | 19.39 | 19.02 |
| 4 | 3.5 | 30 | Site 1 | None | 27 | 17.93 | 19.27 | 18.53 |
| 6 | 3.5 | 30 | Site 2 | 600 | 28 | 16.36 | 18.30 | 17.32 |
| 5 | 3.5 | 20 | Site 2 | 600 | 19 | 15.62 | 17.85 | 16.77 |
| 1 | 3.5 | 20 | Site 2 | None | 19 | 13.03 | 15.73 | 14.62 |
| 3 | 3.5 | 30 | Site 2 | None | — | — | — | — |

The table demonstrates that the percentage of gas incorporated into an aerated, non-cultured dairy-based component is higher on average with a higher fat percentage.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

It is believed that the disclosure and many of its attendant advantages will be understood by the foregoing description, and it will be apparent that various changes may be made in the form, construction and arrangement of the components thereof without departing from the scope and spirit of the disclosure or without sacrificing alt of its material advantages. The form herein before described being merely an explanatory, it is the intention of the following claims to encompass and include such changes.

What is claimed is:

1. A dairy-based product, comprising:
an aerated, non-cultured dairy-based component; and
a stabilizer for stabilizing at least one air cell within the aerated, non-cultured dairy-based component.

2. The dairy-based product as claimed in claim 1, further comprising a second non-cultured dairy-based component.

3. The dairy-based product as claimed in claim 1, wherein a second non-cultured dairy-based component is aerated.

4. The dairy-based product as claimed in claim 1, wherein a second non-cultured dairy-based component is non-aerated.

5. The dairy-based product as claimed in claim 2, further comprising a third non-cultured dairy-based component.

6. The dairy-based product as claimed in claim 2, wherein a third non-cultured dairy-based component is aerated.

7. The dairy-based product as claimed in claim 2, wherein a third non-cultured dairy-based component is non-aerated.

8. The dairy-based product as claimed in claim 1, wherein the dairy-based product has a shelf life of about 12 months or less.

9. The dairy-based product as claimed in claim 1, wherein the aerated, non-cultured dairy-based component has an overrun of about 15% to about 50% by weight.

10. The dairy-based product as claimed in claim 1, wherein the dairy-based product has a fat level of about 2% to about 50% by weight.

11. The dairy-based product as claimed in claim 1, wherein the stabilizer comprises a gum and a gelatin.

12. The dairy-based product as claimed in claim 1, wherein the stabilizer comprises a gum and a gelatin, the gum is at least one of a xanthan gum, a carrageenan gum, a guar gum, a locust bean gum, or a karaya based gum.

13. The dairy-based product as claimed in claim 1, wherein the stabilizer comprises a gum and a gelatin, the gum is about 0.01% to about 0.30% by weight of the dairy-based product.

14. The dairy-based product as claimed in claim 1, wherein the stabilizer comprises a gum and a gelatin, the gelatin is about 0.10% to about 1.0% by weight of the dairy-based product.

15. The dairy-based product as claimed in claim 1, wherein the dairy-based product contains at least one of a whipped pudding or a mousse.

16. The dairy-based product as claimed in claim 1, wherein the dairy-based product contains at least one of pudding or tapioca.

17. A system for producing a dairy-based product, comprising:
a first mixer for mixing components to form a first mix;
a second mixer for mixing the first mix and ingredients to form a final mix;
a pasteurizer for pasteurizing the final mix to form a pasteurized composition;
an aerator for aerating the final mix in the pasteurizer; and
a filler for inserting the pasteurized composition into a package.

18. The system as claimed in claim 17, further comprising a homogenizer for homogenizing the first mix.

19. The system as claimed in claim 17, further comprising a whipper for whipping the pasteurized composition.

20. The system as claimed in claim 17, wherein the pasteurizer is capable of reducing an amount of vegetative organisms and an amount of spores in the dairy-based product.

21. The system as claimed in claim 17, wherein the pasteurizer comprises a scrape surface heat exchanger.

22. The system as claimed in claim 17, wherein the pasteurizer comprises a scrape surface heat exchanger, the scrape surface heat exchanger comprising a heat section, a tower water section, and an ammonia section.

23. The system as claimed in claim 17,
wherein the pasteurizer comprises a scrape surface heat exchanger, the scrape surface heat exchanger comprising a heat section, a tower water section, and an ammonia section, and
wherein the aerator injects gas into the final mix before the final mix enters the tower water section of the scrape surface heat exchanger.

24. The system as claimed in claim 17,
wherein the pasteurizer comprises a scrape surface heat exchanger, the scrape surface heat exchanger comprising a heat section, a tower water section, and an ammonia section, and
wherein the aerator injects gas into the final mix before the final mix enters the ammonia section of the scrape surface heat exchanger.

25. The system as claimed in claim 17, wherein the aerator injects a gas into the final mix to aerate the final mix, the gas is at least one of air or nitrogen.

26. A method for producing a dairy-based product, comprising:
mixing components to form a first mix;
mixing the first mix and ingredients to form a final mix;
pasteurizing the final mix to form a pasteurized composition;
aerating the final mix during pasteurizing; and
inserting the pasteurized composition into a package.

27. The method as claimed in claim 26, further comprising homogenizing the first mix.

28. The method as claimed in claim 26, further comprising whipping the pasteurized composition.

29. The method as claimed in claim 26, wherein the components comprise at least one of oil, sodium stearoyl lactylate, water, or flavorings.

30. The method as claimed in claim 26, wherein the components comprise an oil, the oil comprises about 3.0% to about 6.5% by weight of the non-cultured dairy-based product.

31. The method as claimed in claim 26, wherein the ingredients comprise at least one of sugar, water, starch, coloring, or flavoring.

32. The method as claimed in claim 26, wherein the pasteurizing the final mix provides a shelf life of about 12 months or less.

33. The method as claimed in claim 26, wherein the pasteurizing reduces a number of vegetative microorganisms and a number of spores in the dairy-based product.

34. The method as claimed in claim 26, wherein the aerating the final mix during pasteurizing provides an overrun of about 15% to about 50% by weight of the dairy-based product.

35. The method as claimed in claim 26, wherein the ingredients comprise a stabilizer.

36. The method as claimed in claim 26, wherein the ingredients comprise a stabilizer, the stabilizer comprising a gum and a gelatin.

37. The method as claimed in claim 26,
wherein the ingredients comprise a stabilizer, the stabilizer comprising a gum and a gelatin, and
wherein the gum is at least one of a xanthan gum, a carrageenan gum, a guar gum, a locust bean gum, or a karaya based gum.

38. The method as claimed in claim 26,
wherein the ingredients comprise a stabilizer, the stabilizer comprising a gum and a gelatin, and
wherein the dairy-based product comprises about 0.01% to about 0.30% gum by weight.

39. The method as claimed in claim 26,
wherein the ingredients comprise a stabilizer, the stabilizer comprising a gum and a gelatin, and
wherein the dairy-based product comprises about 0.10% to about 1.0% gelatin by weight.

40. The method as claimed in claim 26, wherein the pasteurizing the final mix to form a pasteurized composition comprises utilizing a scrape surface heat exchanger.

41. The method as claimed in claim 26,
wherein the pasteurizing the final mix to form a pasteurized composition comprises utilizing a scrape surface heat exchanger, and
wherein the aerating the final mix during pasteurizing comprises injecting a gas into the final mix before the final mix is cooled in the scrape surface heat exchanger.
